(19) United States
(12) Patent Application Publication
(10) Pub. No.: US 2003/0142619 A1
(43) Pub. Date: Jul. 31, 2003

(54) Data memory

(76) Inventors: Bernhard Mussig, Seevetal (DE); Jorn Leiber, Hamburg (DE); Steffen Noehte, Weinheim (DE)

Correspondence Address: NIXON & VANDERHYE, PC, 1100 N GLEBE ROAD, 8TH FLOOR, ARLINGTON, VA, 22201-4714, US

(21) Appl. No.: 10/257,866

(22) PCT Filed: Feb. 15, 2001
(86) PCT No.: PCT/EP01/01710

(30) Foreign Application Priority Data
Feb. 23, 2000 (DE) 10008328.5

(51) Int. Cl. G11B 3/70; G11B 5/84; G11B 7/26

(52) U.S. Cl. 369/272; 369/286; 369/287; 369/288

(57) ABSTRACT

A data storage medium (1) has an optical information carrier which comprises a polymer film (11) wound in spiral fashion in a plurality of plies (10), through which information can be read from a preselected polymer film ply (10) and, optionally, written to a preselected polymer film ply (10). A varnish layer (12) set up as an adhesion layer is disposed between adjacent polymer film plies (10).

The invention relates to a data storage medium having an optical information carrier which comprises a polymer film wound in spiral fashion in a plurality of plies, through which information can be read from a preselected polymer film ply and, optionally, written to a preselected polymer film ply.

DE 298 16 802 describes a data storage medium having an optical information carrier which comprises a polymer film. Material specified for the polymer film comprises polymethyl methacrylate and a polymer film marketed by Beiersdorf AG under the designation “tesafilm kristallklar” comprising biaxially oriented polypropylene. In this data storage medium the polymer film is wound in spiral fashion in a plurality of plies onto a winding core, with an adhesion layer being located between each pair of adjacent plies. The adhesion layer is composed of a pressure sensitive acrylate adhesive. Information can be written to the data storage medium by locally heating the polymer film by means of a write beam of a data drive, as a result of which the refractive index and thus the reflecting power (reflectivity) change locally at the interface of the polymer film. This can be detected by means of a read beam in the data drive. By focusing the write beam or the read beam, information can be specifically written to or read from a pre-selected ply of the information carrier. The winding core may be optically transparent and may have in its central area a recess that serves to accommodate the read/write device of a data drive. The read/write device is moved relative to the data storage medium, while the data storage medium is stationary, so that there is no need for the data storage medium to be balanced to take account of a rapid rotational motion.

The acrylate adhesive used in the case of the existing data storage medium is applied in the form of an aqueous dispersion. It is not insensitive to water. Moreover, it is not dimensionally stable, with the consequence that the individual plies of the polymer film may shift with respect to one another (“telescoping” effect) or there may even be changes in thickness between the individual plies over the course of time. Adhesive may be squeezed out at the margins of the wound polymer film. Further disadvantages are fluctuations in thickness of the adhesion layer, and the need for a generally quite high thickness for the adhesion layer. Moreover, the transparency of the adhesive is imperfect, owing to solvent residues.

It is an object of the invention to provide a data storage medium with an optical information carrier which comprises a polymer film wound in spiral fashion in a plurality of plies, in which the individual plies of the polymer film are connected to one another in a dimensionally stable and optically flawless-way.

This object is achieved by a data storage medium possessing the features of claim 1. Claim 13 specifies a method of producing a data storage medium of this kind. Claim 15 relates to the use of a data storage medium of this kind in a drive which is attuned to it. Advantageous embodiments of the invention follow from the dependent claims.

The data storage medium of the invention has an optical information carrier which comprises a polymer film wound in spiral fashion in a plurality of plies. Through these plies, information can be read from a preselected polymer film ply and, optionally, written to a preselected polymer film ply. Disposed between adjacent polymer film plies there is a varnish layer set up as an adhesion layer. The polymer film is preferably wound in at least five plies.

A varnish layer set up as an adhesion layer has better mechanical and optical properties than the acrylate adhesive used in the case of the existing data storage medium. In one preferred embodiment, the varnish of the varnish layer is liquid on processing, solvent-free (i.e., it forms what it known as a 100% system), and curable. After curing, the varnish layer or layers of the data storage medium is or are dimensionally stable, i.e., rigid or substantially rigid, and no longer tacky to the touch. There is no possibility of remaining solvent residues which lead to an impairment of the transparency.

Particularly suitable for the varnish of the varnish layer are transparent, polymerizable resins which preferably comprise a free-radical initiator, which for example can be activated thermally and/or by ultraviolet radiation. Examples thereof are oligomeric acrylates or oligomeric methacrylates containing a thermally activatable free-radical initiator such as, for example, benzoyl peroxide or azoisobutyronitrile (AIBN) or a free-radical initiator which can be activated by ultraviolet radiation (for example, “Irgacure 500” or “Irgacure 1000”, both brands marketed by Ciba Spezialitätenchemie). Likewise suitable are other transparent resins which can be polymerized by free-radical initiators. Additionally, transparent resins polymerizable by means of cationic initiators which can be activated by ultraviolet radiation, such as epoxy resins or vinyl ether resins, for example, are suitable.

In one preferred embodiment of the data storage medium of the invention, the refractive index of the polymer film can be changed locally by heating. Suitable material for the polymer film comprises, for example, biaxially oriented polypropylene (BOPP). If polypropylene, following extrusion to the film, is pretensioned in two planes, a high inherent energy is stored in the material. In the case of local heating, by means of a write beam, for example, there is a severe change in the material as a result of reverse deformation, and this is so even when a relatively small amount of energy is deposited per unit area. In this way it is possible, for example, to achieve a change in refractive index of approximately 0.2 over an area for one stored information unit with a diameter or side length of approximately 1 μm, and this is readily detectable by means of a read beam. So that the varnish layer adheres well to a polymer film made of polypropylene, it may be necessary to pretreat the polymer film, by corona treatment for example. Materials other than polypropylene are likewise conceivable for the polymer film.

To the polymer film, there may be assigned an absorber which is disposed at least partly to absorb a write beam and to emit the generated heat at least partly, locally, to the polymer film. The absorber comprises, for example, dye molecules which are present in the polymer film or in a layer adjacent to the polymer film, and permits local heating of the polymer film, sufficient to change the refractive index, for a relatively low write beam intensity. Suitable layers adjacent to the polymer film and able to comprise the absorber include the varnish layer between two adjacent plies of the polymer film, or an absorber layer provided independently for this purpose. In the latter case, therefore, not only a varnish layer set up as an adhesion layer but also an absorber layer is located between adjacent polymer film plies. (In the case of further embodiments of the data storage medium, besides a varnish layer there may be one or more layers having different or additional functions disposed between adjacent polymer film plies.)

Preferably, the refractive index of the varnish layer differs only slightly from the refractive index of the polymer film, in order to minimize disruptive reflections of a read beam or of a write beam at a boundary between a polymer film ply and an adjacent varnish layer. It is particularly advantageous if the difference in the refractive indices is less than 0.005. Any difference which does exist between the refractive indices may be utilized, however, for the purpose of formatting the data storage medium.

A data storage medium of the invention with spirally wound polymer film and curable varnish in the varnish layer can be produced by applying the varnish of the varnish layer to at least one side of a polymer film and winding the polymer film in spiral fashion. The varnish of the varnish layer is cured during winding and/or after the end of the winding operation. The varnish is applied to the polymer film preferably using a doctor blade. Other methods of applying the varnish are likewise conceivable: for example, spraying or brushing. The polymer film may be wound onto a winding core, a transparent winding core for example, which remains behind on the data storage medium. Another possibility consists in winding the polymer film onto a winding element which is subsequently removed from the central region of the data storage medium. The result is a dimensionally stable data storage medium having a spirally wound polymer film which can no longer be unwound and which does not undergo telescopelike shifting. Moreover, the varnish layer between adjacent polymer film plies exhibits a high level of transparency, thereby facilitating the reading of data from and, where appropriate, the writing of data to the data storage medium.

If the data storage medium is wound in spiral fashion and has a recess in its central region, in a winding core, for example, it is possible to dispose in said recess a read device and optionally a write device of a drive which is attuned to the data storage medium and to move said device(s) relative to the data storage medium, while the data storage medium is stationary, for the purpose of reading and, respectively, writing information. A stationary data storage medium has the advantage that there is no need to balance it in order to allow high rotational speeds, which has a favorable effect on the production costs.

The invention is described in more detail below with reference to examples. The drawing shows in

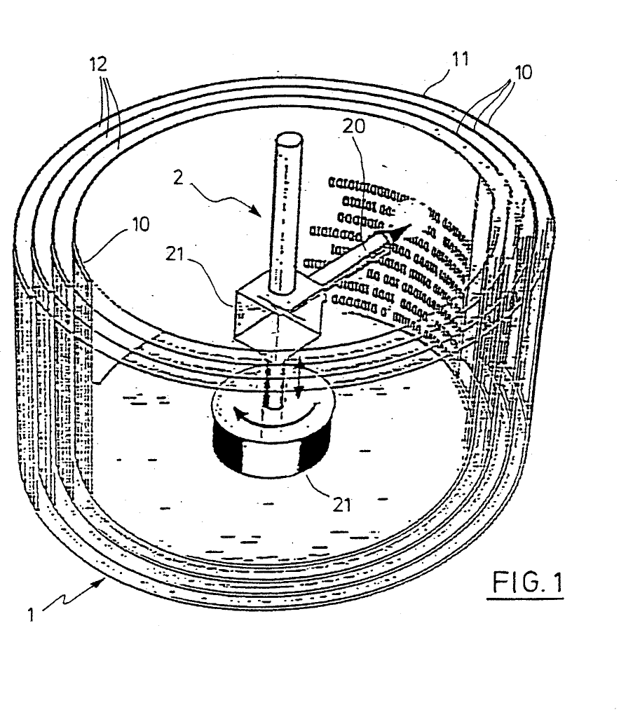

FIG. 1 a data storage medium comprising a spirally wound polymer film, in diagrammatic perspective representation, parts of a drive attuned to the data storage medium being arranged in a recess in the central region of the data storage medium.

FIG. 1 shows in diagrammatic representation a data storage medium 1 and a read/write device 2 of a drive attuned to the data storage medium 1. The data storage medium 1 comprises a number of plies 10 of a polymer film 11 which serves as information carrier and is wound in spiral fashion onto an optically transparent winding core. For clarity, the winding core is not depicted in FIG. 1; it is located within the innermost ply 10. For improved illustration, the individual plies 10 of the polymer film 11 have been shown in FIG. 1 as concentric rings, although the plies 10 are formed by spiral winding of the polymer film 11. Between each pair of adjacent plies 10 of the polymer film 11 there is a varnish layer 12 which serves as an adhesion layer. Consequently, the individual varnish layers 12 are all connected and as a whole, just like the polymer film 11, have a spiral course. For reasons of clarity, the varnish layers 12 have been drawn in FIG. 1 in an increased thickness which is not to scale.

In the example, the polymer film 11 is composed of biaxially oriented polypropylene (BOPP) and has been pretensioned in both surface directions prior to winding. In the example the polymer film 11 has a thickness of 35 μm; other thicknesses in the range from 10 μm to 100 μm or even thicknesses lying outside of this range are likewise conceivable. The varnish layers 12 are free from gas bubbles and in the example are composed of a methacrylate varnish (see below) which is curable by means of ultraviolet radiation and to which there has been admixed an absorber dye with a thickness of 23 μm, preferred layer thicknesses being situated between 1 μm and 40 μm. In the example, the data storage medium 1 comprises twenty plies 10 of the polymer film 11 and has an external diameter of approximately 30 mm. Its height is 19 mm. A different number of plies 10, or different dimensions, are likewise possible. The number of windings or plies 10 may, for example, be between ten and thirty, or else may be greater than thirty.

The read/write device 2 disposed in the interior of the winding core is known in principle from, for example, DVD technology. The read/write device 2 contains a read/write head 20 which can be moved backward and forward axially and rotated in the directions of the arrows that have been drawn in, by means of a mechanism 21. The read/write head 20 has optical elements by means of which a light beam (of wavelength, for example, 630 nm or 532 nm) produced by a laser, which is not shown in FIG. 1, may be focused onto the individual plies 10 of the polymer film 11. Since the read/write head 20 is moved by means of the mechanism 21, it is able to scan fully all of the plies 10 of the data storage medium 1. In the example, the data storage medium 1 is stationary. Consequently, it does not need to be balanced to take account of a high rotational speed (and also need not be unwound or rewound), unlike the read/write head 20. For the sake of clarity, the elements provided for balancing the read/write head 20 have not been shown in FIG. 1. The laser mentioned is located outside of the read/write head 20 and is stationary; the laser beam is guided into the read/write head 20 via optical elements.

For the purpose of storing or writing information in or to the data storage medium 1, the laser in the example is operated with a beam power of approximately 1 mW. The laser beam serves as a write beam and is focused onto a preselected ply 10 of the polymer film 11 in such a way that the beam spot is smaller than 1 μm. The light energy is introduced in the form of short pulses of approximately 10 μs in duration. The energy of the write beam is absorbed in the beam spot, promoted by the absorber in the adjacent varnish layer 12, leading to a local heating of the polymer film 11 and hence to a local change in the refractive index and in the reflectivity. During the write operation, the write beam is defocused in the plies adjacent to the relevant ply 10 of the polymer film 11, so that the adjacent plies of the polymer film 11 undergo only slight heating, locally, and the stored information is not altered there.

In order to read stored information from the data storage medium 1, the laser in the example is operated in continuous wave mode (CW mode). The read beam focused onto the desired site is reflected as a function of the stored information, and the intensity of the reflected beam is detected by a detector in the read/write device 2.

The data storage medium may also be of an embodiment which cannot be written by the user. In this case it contains information units written by the manufacturer. There is then no need for a write function in the user's data drive.

In the polymer film 11, the information units are formed by changing the optical properties in a region having a preferred size of less than 1 μm. The information may be stored in binary form; i.e., the local reflectivity adopts only two values at the site of one information unit. In other words, if the reflectivity is above a fixed threshold value, a “1”, for example, is stored at the site in question on the information carrier, and, if it is below this threshold value or below a different, lower threshold value, a “0” is stored correspondingly. It is, however, also conceivable for the information to be stored in a plurality of gray stages. This is possible if the reflectivity of the polymer film at the site of an information unit can be altered specifically by defined adjustment of the refractive index without saturation being reached.

In order to produce the data storage medium 1, a polymer film 11 made of biaxially oriented polypropylene is used which has been subjected beforehand to Corona treatment on both sides in order to improve the adhesion properties for varnish. The polymer film 11 is wound in spiral fashion onto the abovementioned winding core, by turning the winding core. During the winding operation a varnish is applied uniformly to one side of that region of the polymer film 11 that has not yet been wound, using a doctor blade. In the example the varnish is composed of oligomeric methacrylate admixed with a sufficient amount of an absorber dye (in this case Sudan Red 7B) to give an optical density (see below) of approximately 0.1 to 0.3 per ply, and 0.5% by weight of a free-radical initiator which can be activated by ultraviolet radiation. In the example, the free-radical initiator is a free-radical initiator of the brand “Irgacure 500” or “Irgacure 1000” from Ciba Spezialitätenchemie. The zone in which that region of the polymer film 11 that has not yet been wound is adjacent to the region which has already been wound is irradiated with ultraviolet light. This activates the free-radical initiator in the varnish, so that the varnish cures even during the winding operation to such an extent that the polymer film plies 10 that have already been wound are no longer able to shift relative to one another. After the end of the winding operation, irradiation of the data storage medium 1 with ultraviolet light is continued until the varnish has cured right through.

Further examples of the varnish are epoxy resin systems which already contain the initiator (e.g., the brands “Vitralit 1558” or “Vitralit 1505”, from Panacol-Elosol), and also UV-curing acrylate adhesives (e.g., the brands “Vitralit 1810”, “Vitralit 5638” or “Vitralit 7104”, from Panacol-Elosol, or the brand “302”, from Loctite; these four products likewise already contain the initiator).

An absorber dye may also be present in the polymer film. In another embodiment, a separate layer containing absorber dye is provided in addition to the polymer film 11 and the varnish layers 12. In this case it is appropriate first to apply the layer containing absorber dye to one side of the polymer film 11 and then to wind up the polymer film 11, provided with this absorber layer, with addition of varnish, as described above.

In the case of absorption the optical density is the product of the absorption constant (which depends on the concentration of an absorber dye) and the layer thickness through which radiation takes place, and is a variable well suited to characterizing the absorption behavior. At the light wavelength of a write beam, the optical density is preferably situated in the range from 0.1 to 0.3 per ply (polymer film plus varnish layer plus any additional layers such as, for example, layer containing absorber dye), but may also be smaller or larger.

1. A data storage medium having an optical information carrier which comprises a polymer film (11) wound in spiral fashion in a plurality of plies (10), through which information can be read from a preselected polymer film ply (10) and, optionally, written to a preselected polymer film ply (10), a varnish layer (12) set up as an adhesion layer being disposed between adjacent polymer film plies (10).

2. The data storage medium as claimed in claim 1, characterized in that the polymer film (11) is wound in at least five polymer film plies (10).

3. The data storage medium as claimed in claim 1 or 2, characterized in that the polymer film (11) is wound on a winding core.

4. The data storage medium as claimed in any of claims 1 to 3, characterized in that the refractive index of the polymer film (11) can be changed locally by heating.

5. The data storage medium as claimed in claim 4, characterized in that an absorber is assigned to the polymer film (11), which absorber is set up to absorb, at least partly, a write beam and to transfer the generated heat, at least partly, locally to the polymer film (11).

6. The data storage medium as claimed in any of claims 1 to 5, characterized in that the refractive index of the varnish layer (12) differs only slightly from the refractive index of the polymer film (11).

7. The data storage medium as claimed in any of claims 1 to 6, characterized in that the varnish of the varnish layer (12) is solvent-free.

8. The data storage medium as claimed in claim 7, characterized in that the varnish of the varnish layer (12) is curable.

9. The data storage medium as claimed in claim 8, characterized in that the varnish of the varnish layer (12) is a transparent, polymerizable resin.

10. The data storage medium as claimed in claim 9, characterized in that the varnish of the varnish layer (12) comprises at least one of the constituents selected from the following group: oligomeric acrylates, oligomeric methacrylates, epoxy resins, vinyl ether resins.

11. The data storage medium as claimed in claim 9 or 10, characterized in that the varnish of the varnish layer (12) comprises a free-radical initiator.

12. The data storage medium as claimed in claim 11, characterized in that the free-radical initiator can be activated thermally and/or by ultraviolet radiation.

13. A method of producing a data storage medium having the features of claim 8, the varnish of the varnish layer (12) being applied to at least one side of a polymer film (11), the polymer film (11) being wound in spiral fashion, and the varnish of the varnish layer (12) being cured during winding and/or after the end of the winding operation.

14. The method as claimed in claim 13, characterized in that the varnish is applied using a doctor blade.

15. The use of a data storage medium as claimed in claim 1, having a recess in its central region, in a drive which is attuned to it and comprises a read device (2) and optionally a write device (2), the read device (2) and the optional write device (2) being disposed in the recess in the central region of the data storage medium (1) and being moved relative to the data storage medium (1), while the data storage medium (1) is stationary, for the purpose of reading and, respectively, writing information.
